(19) United States
(12) Patent Application Publication
(10) Pub. No.: US 2009/0107932 A1
(43) Pub. Date: Apr. 30, 2009

(54) Motorcycle vice

(76) Inventor: Gary M. Henthorn, Camarillo, CA (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 11/982,123

(22) Filed: Oct. 31, 2007

(51) Int. Cl. B62H 3/04; A47F 7/04

(52) U.S. Cl. 211/20

(57) ABSTRACT

The present invention relates to a motorcycle vice. The motorcycle vice can be used with, for example, a lift or a ramp. The motorcycle device can be placed in a first closed position for receiving a motorcycle or in a second open position where it is out of the way.

### FIELD OF THE INVENTION

The present invention relates to a motorcycle vice. The inventive vice is especially intended for use by, for example, home users and bike shops, especially where space is at a premium. In one embodiment, the inventive vice is used on a hydraulic lift, such as a 4 post automotive hydraulic lift. One advantage of the inventive motorcycle vice is that it can be easily moved or flipped out of the way when not in use.

### BACKGROUND OF THE INVENTION

A number of motor cycle vices are known in the art. Many of them rest on the ground. Some are fixed in place, some are on a flat base, and some have wheels so that they can be moved. Some motorcycle vices are adjustable so that they can be clamped onto, e.g., a motorcycle wheel.

A problem occurs when, for example, a motorcycle vice is used on a lift, such as a 4 post automotive hydraulic lift. When in place, the motorcycle vice can prevent the lift from being used for, e.g., automobiles because the motorcycle vice will be in the way.

Accordingly, it is an object of the present invention to provide for an improved motorcycle vice.

It is a further object of the present invention to provide for an improved motorcycle vice which can be used on a lift.

It is still further object of the present invention to provide for an improved motorcycle vice which can be used on a lift and which can be swung out of the way when not in use.

### SUMMARY OF THE INVENTION

The present invention relates to an improved motorcycle vice which can be used on a lift, such as a hydraulic automobile lift, or a ramp, or the like. The motorcycle vice of the present invention includes a rotation means so that the motorcycle vice can be swung or rotated out of the way when not in use, i.e. is not blocking the lift, ramp or the like. In this way, the lift, ramp or the like can easily be used with other vehicles, such as automobiles, trucks, tractors, etc. In one embodiment, the motorcycle vice is adjustable to insure a secure fastening or grip onto the motorcycle, such as onto a motorcycle tire. In another embodiment, the motorcycle vice has a stopping means to prevent the motorcycle vice from being swung or rotated too far in the open position.

### BRIEF DESCRIPTION OF THE DRAWINGS

FIG. 1A is a view of the inventive motorcycle vice in the open position.

FIG. 1B is a view of the inventive motorcycle vice in the closed position.

FIG. 2 is an exploded view of the inventive motorcycle vice.

FIG. 3 is a blow up of the left block assembly of the inventive motorcycle vice.

FIG. 4 is a view of a limit plate assembly of the inventive motorcycle vice.

### DETAILED DESCRIPTION OF THE INVENTION

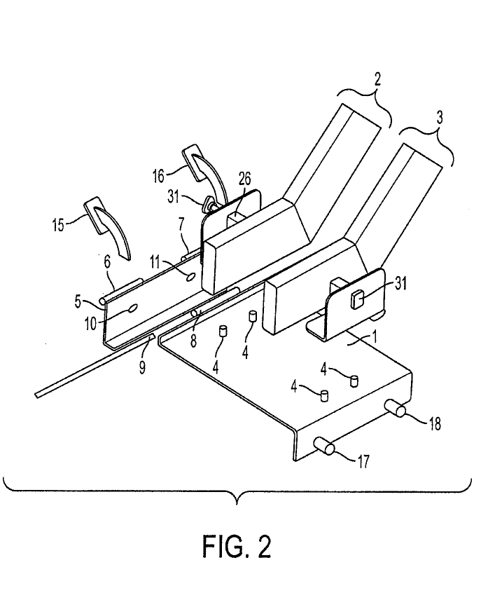

Referring first to FIG. 2, there is shown a base (1) with a left block assembly (2) and a right block assembly (3) attached to it. The block assemblies (2, 3) can be fixedly attached to the base (1) via securing members (4) which can be threaded. In an alternative embodiment (not shown), the block assemblies (2, 3) are slidably attached to the base (1).

It should be noted that while reference is made to block assemblies, there is no requirement that these assemblies be blocks or cubes. Rather, any assembly which can support a motorcycle, such as by a wheel or by the frame, is understood to come within the scope of the present invention.

The base (1) is rotatably attached to a rotation block or plate (5). As shown in FIG. 2, this rotatable attachment is accomplished via interweaving tubes (6, 7) on the rotation block (5) and an interweaving tube (8) on the base (1), which function together like a hinge, although the number of tubes or other means of providing a rotatable attachment are included within the scope of this invention. As shown in FIG. 2, the interweaving tubes (6, 7) on the rotation block (5) and the interweaving tube (8) on the base (1) are held together via a bar (9). These interweaving tubes (6,7,8) can be formed as integral parts of the base (1) and rotation block (5) or can be separate components attached to them, such as by welding.

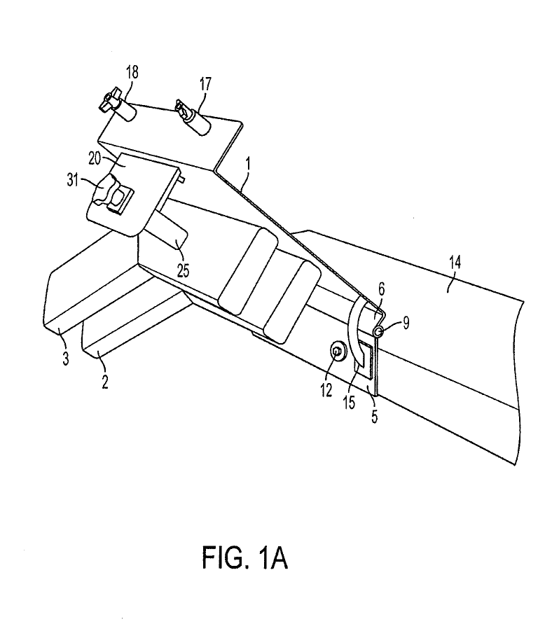

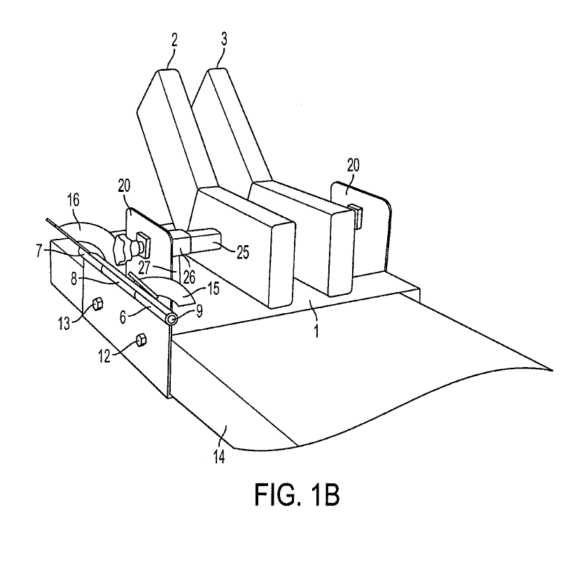

The rotation block (5) includes holes (10, 11). These holes (10, 11) are configured to accept bolts (12, 13) as shown in FIG. 1B to hold the inventive motorcycle vice to, for example, a tongue (14) of a lift. It is understood, however, that other fixing means, such as spring loaded push rods or a clamp, or no fixing means (and thus no need for holes) can be used.

As also shown in FIG. 2, a preferred embodiment of the inventive motorcycle vice includes limit plate assemblies (15, 16). These prevent the motorcycle vice from opening too widely, as shown in FIG. 1A.

Also a preferred embodiment, as shown in FIG. 2, the motorcycle vice includes fasteners (17, 18). These fasteners can be, for example, spring loaded or screw type devices. They function to hold the motorcycle vice securely to the tongue (14) in when in the closed position, as shown in FIG. 1B.

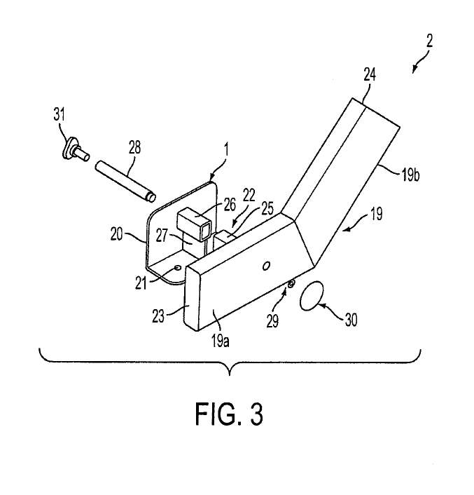

FIG. 3 shows a blow up of an embodiment of the left block assembly (2). It is understood that the right block assembly (3) can have a similar albeit mirror image configuration.

The block assembly includes a block (19) and a back plate (20). The back plate (20) of FIG. 3 is of the fixed type. It includes holes which cooperate with the securing members (4) attached to the base (1). For example, if the securing members (4) are threaded, then bolts (not shown) can be used to secure the back plate (20) to the base (1).

The block (19) is preferably hollow, e.g., a rectangular tube. It can be constructed of two pieces (19a, 19b) held together by, e.g., welding. The ends of the block (19) can be left open or capped off using block cap members (23, 24). These can be held in place by, for example, welding.

The block (19) can include a male rectangular member (25) which cooperates with a female rectangular member (26) attached to the back plate (20). These rectangular members (25, 26) can be held in place by any conventional means, such as by welding. As so configured, the male rectangular member (25) fits inside the female rectangular member (26) and can slide back and forth, thereby imparting mobility to the block (19). Optionally included is a female rectangular member support plate (27), affixed to the back plate (19) and the female rectangular member (25) to add additional support and strength to the female rectangular member (25).

One embodiment for controlling the movement of the block (19) is shown in FIG. 3. It comprises a threaded movement member (28) which is rotatably attached to the block (19). It can be attached to the block (19) via, for example, a snap ring (29) which can be covered by a cover member (30). The threaded movement member (28) passes through the male (25) and female (26) rectangular members and the back plate (20). The back plate (20) or female rectangular member (26) can have a nut member (not shown) attached to it, where the nut member is threaded to cooperate with the threaded movement member (28). The threaded movement member (28) can also terminate in a knob (31). Thus, when turned, the knob will cause rotation of the threaded movement member (28) through the nut member causing the block (19) to move. The block (19) can move in towards its opposite member away from it. In this way, the grip on a motorcycle part, such as a motorcycle wheel, can be adjusted.

The above is only one embodiment for this invention. For example, using a configuration similar to the above, the movement member (28) need not be threaded. Rather its movement can be stopped by a clamp, vice or other pressure fitting attached to, e.g., the back plate. Here, pressure is removed allowing movement and applied to prevent movement.

Also, the above describes movement for the left block assembly (2). It is understood that optionally, this configuration can be used on the right block assembly (3) or on both.

It is also understood that the back plate (20) can be slidably mounted to the base (1). This can be true for the left block assembly (2), the right block assembly (3) or both. It is further understood that each block assembly (2, 3), either alone or each of them, can include a combination of the above movement means.

It may be desirable to control or limit the movement of the inventive motorcycle vice when it is swung open. This is shown in FIG. 1A. For example, if the motorcycle vice is allowed to open to its maximum extent and it is mounted on a hydraulic lift, the motorcycle vice may interfere with the action of the lift when it is being lowered. Thus, stopping means can be employed to limit the movement of the motorcycle vice when it is opened.

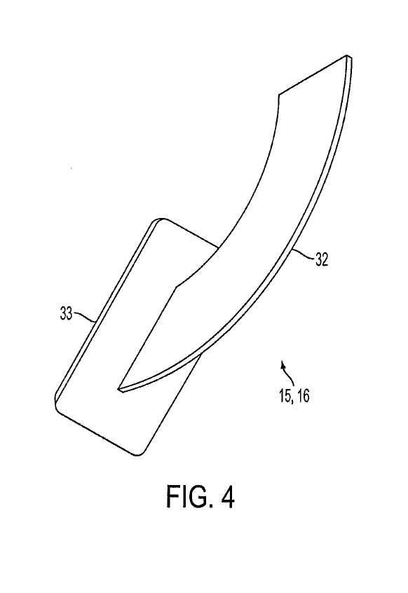

As shown in FIGS. 1A, 2 and 4, one type of stopping means is a pair of limit plate assemblies (15, 16). These each comprise an arm (32) and a face plate (33) which can be attached to each other by conventional means, such as welding. The limit plate assemblies (15, 16) are attached to the base (1) via conventional means, such as welding. The operation of the limit plate assemblies (15, 16) in limiting the movement of the motorcycle vice in the open position is shown in FIG. 1A where the face plate (33) comes in contact with the rotation block (5). Of course, the present invention is not limited to two limit plate assemblies. Rather, one, three or any other desired number can be used.

The functioning of the inventive motorcycle vice can thus be seen. When not in use, it is in its open position, allowing the lift or ramp to be used with other vehicles. Preferably, in the open position, the motorcycle vice swings out away from the vehicle although if the user prefers, it can be configured to swing inward so that it would go towards or under the vehicle. Also, when open, stopping means are provided to prevent the motorcycle vice from opening too wide. When needed for use, the inventive motorcycle device is swung closed. A motorcycle can then be wheeled onto the motorcycle vice. And, as described above, means are provided to allow clamping onto the motorcycle or a part thereof, such as the wheel, to hold the motorcycle steady.

The above description is of various embodiment of the invention, and is not meant to be limiting on the scope of the invention claimed.

What is claimed is:

1. A motorcycle vice comprising:
a. a base;
b. an assembly attached to the base for supporting a motorcycle; and
c. a rotation block rotatably attached to the base so that the base and assembly can be rotated into a first closed position for receiving the motorcycle and into a second open position.

2. The motorcycle vice of claim 1 wherein the assembly comprises a right block assembly and a left block assembly.

3. The motorcycle vice of claim 1 wherein the assembly is adjustable to produce a desired support for the motorcycle.

4. The motorcycle vice of claim 1 further comprising a stopping means to limit the amount the motorcycle device can be opened when it is in the second open position.

5. The motorcycle vice of claim 4 wherein the stopping means comprises one or more limit plate assemblies, wherein each limit plate assembly comprises an arm affixed to the base and a face plate affixed to the arm configured so that when the motorcycle vice is in the second open position, the face plate contacts the rotation block.

6. The motorcycle vice of claim 2 wherein each block assembly comprises a back plate affixed to the base and a block affixed to the back plate.

7. The motorcycle vice of claim 6 where in one or both back plates are slidably affixed to the base.

8. The motorcycle vice of claim 6 wherein each back plate is fixedly attached to the base.

9. The motorcycle vice of claim 7 wherein one or both blocks are slidably affixed to each block's back plate.

10. The motorcycle vice of claim 8 wherein one or both blocks are slidably affixed to each block's back plate.

11. A motorcycle vice comprising;
a. a base;
b. an assembly for supporting a motorcycle, wherein the assembly comprises a right block assembly and a left block assembly, each block assembly comprising a base plate fixedly attached to the base and a block slidably attached to each base plate;
c. a rotation block rotatably attached to the base so that the base and assembly can be rotated into a first closed position for receiving the motorcycle and into a second open position; and
d. one or a plurality of limit plate assemblies for limiting the amount the motorcycle vice can be opened when it is in the open position, each limit plate assembly comprising an arm affixed to the base and a face plate affixed to the arm, configured so that when the motorcycle vice is in the second open position, the face plate contacts the rotation block.
